(19) United States
(12) Patent Application Publication
(10) Pub. No.: US 2009/0090615 A1
(43) Pub. Date: Apr. 9, 2009

(54) Apparatus and method for controlling the oxidation state of catalyst

(75) Inventors: Chun-Ching Chien, Taipei City (TW); Shean-Du Chiou, Pingzhen City (TW); Su-Hsine Lin, Longtan Shiang (TW); Ning-Yih Hsu, Keelung City (TW)

Correspondence Address: TROXELL LAW OFFICE PLLC, 5205 LEESBURG PIKE, SUITE 1404, FALLS CHURCH, VA, 22041, US

(73) Assignee: ATOMIC ENERGY COUNCIL - INSTITUTE OF NUCLEAR ENERGY RESEARCH, Taoyuan (TW)

(21) Appl. No.: 11/905,874

(22) Filed: Oct. 5, 2007

(51) Int. Cl. B01J 19/08

(52) U.S. Cl. 204/164; 422/186.04

(57) ABSTRACT

An apparatus is disclosed for controlling the oxidation state of catalyst for use in a fuel cell. The apparatus includes a holder, a working electrode disposed in the holder, an auxiliary electrode located right above the working electrode, a reference electrode disposed in the holder and a power supply connected to all of the electrodes.

### BACKGROUND OF INVENTION

1. Field of Invention

The present invention relates to a fuel cell and, more particularly, to an apparatus and method for controlling the oxidation state of catalyst for use in a fuel cell.

2. Related Prior Art

A membrane electrode assembly (“MEA”) for use in a fuel cell must be subjected to an activation process. Thus, the oxidation state of catalyst used in the MEA can be given a desired value, and the MEA can provide a needed discharge power.

It however takes a long period of time for the activation process to complete. Furthermore, different catalyst requires different activation processes that take different periods of time to complete. It is difficult for an operator to remember the different periods of time. Moreover, the oxidation state of the catalyst is limited because of the material thereof and the activation process. The oxidation state of the catalyst is given a predetermined value that may not be exactly what is preferred. Hence, other parameters of the fuel cell must be set to compensate the gap between the predetermined value and the preferred value.

The present invention is therefore intended to obviate or at least alleviate the problems encountered in prior art.

### SUMMARY OF INVENTION

It is an objective of the present invention to provide an apparatus for controlling the oxidation state of catalyst for use in a fuel cell.

To achieve the foregoing objective, an apparatus includes a holder, a working electrode disposed in the holder, an auxiliary electrode located right above the working electrode, a reference electrode disposed in the holder and a power supply connected to all of the electrodes.

It is another objective of the present invention to provide a method for controlling the oxidation state of catalyst for use in a fuel cell.

To achieve the foregoing objective, a method includes the step of providing a working electrode, the step of providing catalyst powder evenly on the working electrode, the step of providing a holder, the step of disposing the working electrode in the holder, the step of providing an auxiliary electrode right above the catalyst powder, the step of providing a reference electrode in the holder, the step of providing a power supply, the step of connecting all of the electrodes to the power supply and the step of turning on the power supply to energize all of the electrodes to control the oxidation state of the catalyst powder.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of an apparatus for controlling the oxidation state of catalyst for use in a fuel cell according to the preferred embodiment of the present invention.

FIG. 2 is an exploded view of the apparatus shown in FIG. 1.

FIG. 3 is a side view of catalyst disposed in a portion of the apparatus shown in FIG. 1.

FIG. 4 is a side view of the catalyst disposed in another portion of the apparatus shown in FIG. 1.

FIG. 5 is a side view of the catalyst disposed in the apparatus shown in FIG. 1.

### DETAILED DESCRIPTION OF PREFERRED EMBODIMENT

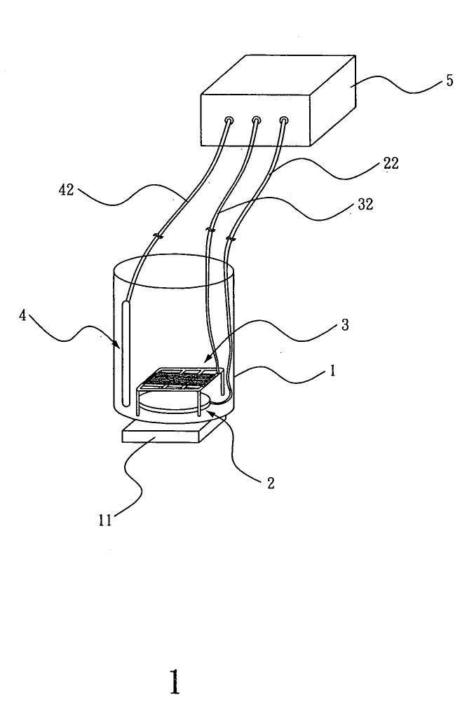

Referring to FIG. 1, there is shown an apparatus for controlling the oxidation state of catalyst for use in a fuel cell according to the preferred embodiment of the present invention. The apparatus includes a holder 1, a working electrode 2, an auxiliary electrode 3, a reference electrode 4 and a power supply 5.

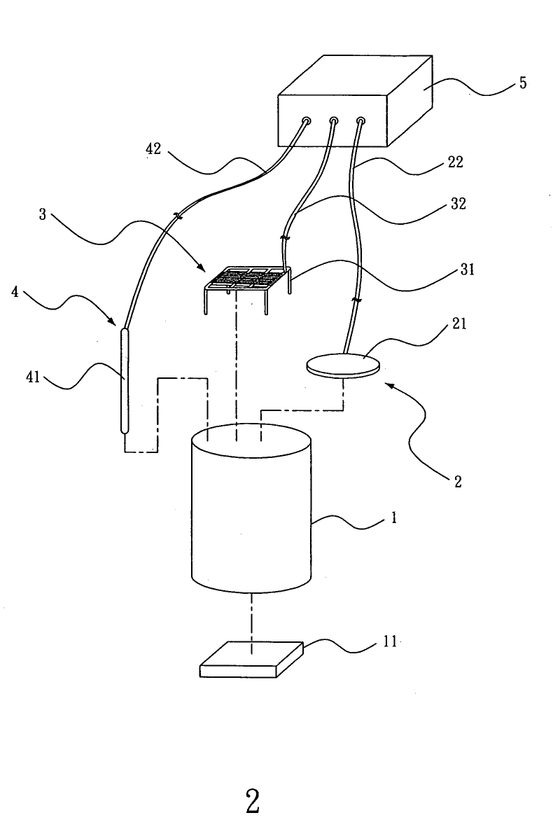

Referring to FIG. 2, a striking unit 11 is provided beneath the holder 1 so that the striking unit 11 can be activated to vibrate the holder 1.

The working electrode 2 includes a plate 21 disposed in the holder 1 and a wire 22 connected to the plate 21. Both of the plate 21 and the wire 22 are made of a conductive material.

The auxiliary electrode 3 includes a stand 31 disposed above the plate 21 in the holder 1 and a wire 32 wound around the stand 31. The stand 31 is made of an insulating material such as glass. The wire 32 is of course made of a conductive material.

The reference electrode 4 includes a rod 41 inserted in the holder 1 and a wire 42 connected to the rod 41. Both of the rod 41 and the wire 42 are made of a conductive material.

The power supply 5 is connected to all of the wires 22, 32 and 42.

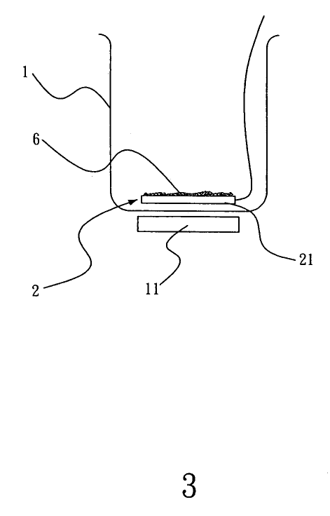

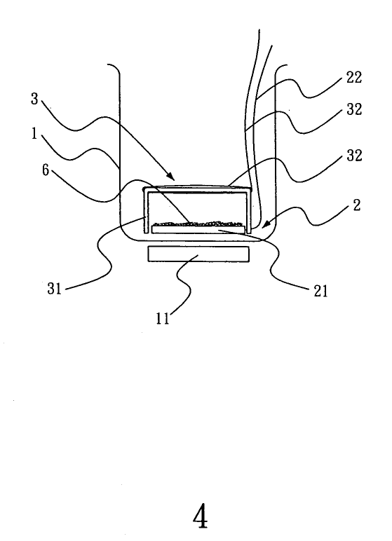

In a method for controlling the oxidation state of catalyst according to the preferred embodiment of the present invention, the plate 21 of the working electrode 2 is disposed in the holder 1 as shown in FIG. 3. Catalyst powder 6 is provided on the plate 21. The striking unit 11 is activated to vibrate the holder 1, the plate 21 and the catalyst powder 6 so that the catalyst powder 6 is evenly distributed on the plate 21. Referring to FIG. 4, the stand 31 and the wire 32 of the auxiliary electrode 3 are disposed in the holder 1. The portion of the wire 32 wound around the stand 31 is located right above the catalyst powder 6.

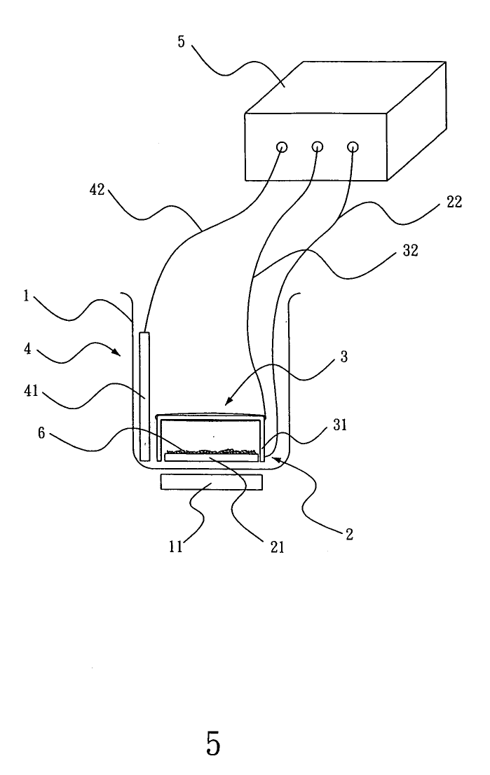

Referring to FIG. 5, the rod 41 of the reference electrode 4 is inserted in the holder. All of the wires 22, 32 and 42 are connected to the power supply 5.

Finally, the power supply 5 is turned on to energize the working electrode 2, the auxiliary electrode 3 and the reference electrode 4 to control the oxidation state of the catalyst powder 6. Thus, the oxidation state of the catalyst powder 6 is given a value that is exactly what is preferred in use.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for controlling the oxidation state of catalyst for use in a fuel cell, the apparatus comprising:
a holder;
a working electrode disposed in the holder;
an auxiliary electrode located right above the working electrode;
a reference electrode disposed in the holder; and
a power supply connected to all of the electrodes.

2. The apparatus according to claim 1 comprising a striking unit located beneath the holder.

3. The apparatus according to claim 1, wherein the working electrode comprises a plate disposed in the holder and a wire for connecting the plate to the power supply.

4. The apparatus according to claim 1, wherein the auxiliary electrode comprises an insulating stand disposed in the holder and a wire wound around the insulating stand and connected to the power supply.

5. The apparatus according to claim 1, wherein the insulating stand is made of glass.

6. The apparatus according to claim 1, wherein the reference electrode comprises a rod disposed in the holder and a wire for connecting the rod to the power supply.

7. A method for controlling the oxidation state of catalyst for use in a fuel cell, the method comprising the steps of:
providing a working electrode;
providing catalyst powder evenly on the working electrode;
providing a holder;
disposing the working electrode in the holder;
providing an auxiliary electrode right above the catalyst powder;
providing a reference electrode in the holder;
providing a power supply;
connecting all of the electrodes to the power supply; and
turning on the power supply to energize all of the electrodes to control the oxidation state of the catalyst powder.

8. The method according to claim 7 comprising the step of providing a striking unit beneath the holder so that the striking unit can vibrate the holder, the working electrode and the catalyst powder so that the catalyst powder is evenly distributed on the working electrode.

9. The method according to claim 7, wherein the working electrode comprises a plate disposed in the holder and a wire for connecting the plate to the power supply.

10. The method according to claim 7, wherein the auxiliary electrode comprises an insulating stand disposed in the holder and a wire wound around the insulating stand and connected to the power supply.

11. The method according to claim 10, wherein the insulating stand is made of glass.

12. The method according to claim 7, wherein the reference electrode comprises a rod disposed in the holder and a wire for connecting the rod to the power supply.
